(19) United States
(12) Patent Application Publication
(10) Pub. No.: US 2005/0202970 A1
(43) Pub. Date: Sep. 15, 2005

(54) Agent and a method for removing ethidium bromide in a waste solution

(75) Inventors: Fong-Ming Lu, Taipei City (TW); Wanhua Annie Hsieh, Hualien City (TW)

Correspondence Address: Scully, Scott, Murphy & Presser, 400 Garden City Plaza, Garden City, NY, 11530-3319, US

(73) Assignee: Taiwan Proteomics Co., Ltd., Hualien City (TW)

(21) Appl. No.: 10/915,184

(22) Filed: Aug. 10, 2004

(30) Foreign Application Priority Data
Aug. 15, 2003 (TW) 92122530

(51) Int. Cl. B01J 20/20

(52) U.S. Cl. 502/416

(57) ABSTRACT

Ethidium bromide is a carcinogen. After carrying out relevant DNA or RNA experiments, there is generally produced a waste solution or a pollutant containing ethidium bromide and thus in a laboratory such a waste solution and pollutant must be particularly treated in a way identical to the treatment of poisonous materials. To date, there are several methods for treating the waste solution or the pollutant containing ethidium bromide, but these methods all have their defects. For instance, the treatment method is too complicated, a strong acid and a strong base harmful to humans are used in treatment, the cost for treatment is too expensive, ethidium bromide present in the solution is merely concentrated through physical adsorption and thus the carcinogenicity of ethidium bromide is not destroyed, and after treatment other carcinogens which can not be removed are still produced in a minor amount. Therefore, for the relevant laboratory, treatment of a waste solution containing ethidium bromide is still a problem that is bothersome and seeks solution. The present invention relates to an agent for simultaneously rapidly destroying ethidium bromide and adsorbing carcinogens produced in minor amount after reaction, and a rapid, simple, economic and safe method for completely removing the carcinogenicity of ethidium bromide contained in a waste solution by using said agent. Said agent comprises (1) an activated carbonous material, (2) at least one of the compounds selected from hypochlorite, chlorite and chloro-containing compound, and optionally (3) an inorganic mineral. When treating the carcinogenic waste solution containing ethidium bromide, said agent is merely thrown to the carcinogenic waste solution containing ethidium bromide collected in a barrel. After reaction for a period of from 5 minutes to 20 minutes, thus treated waste solution may be directly discarded into a sink so as to complete the treatment of the carcinogenic waste solution.

### THE FIELD OF THE INVENTION

The present invention relates to an agent for simultaneously destroying ethidium bromide through chemical reaction and adsorbing a minor amount of carcinogens produced after reaction, and a method for treating a carcinogenic waste solution containing ethidium bromide.

### BACKGROUND OF THE INVENTION

Ethidium bromide which is denominated as 3,8-diamino-5-ethyl-6-phenylphenthanridinium bromide according to International Union of Pure and Applied Chemistry has, as its feature a flat structure and shows a reddish-orange fluorescence under ultraviolet light. Due to the flat structure, ethidium bromide can be embedded into the structure of double-stranded DNA or RNA and in turn is tightly bound thereto (J. Mol. Bio. 1967, 27, 87) (Biochemistry 1973, 12, 214). In general, when carrying out relevant DNA or RNA experiments, ethidium bromide is used as a dyeing agent. After performing a gel electrophoresis on DNA or RNA, the electrophoresis gel containing DNA or RNA is soaked into a solution containing ethidium bromide so that ethidium bromide is bound to DNA or RNA. Afterward, when the electrophoresis gel is irradiated by an ultraviolet ray, ethidium bromide shows a reddish-orange fluorescence to make a person be able to visually recognize the presence of DNA. Because ethidium bromide is bound to DNA so that ethidium bromide further affects or interferes with the duplication of DNA and thereby causes mutation of DNA (Mutat. Res. 1977, 48, 103). The variation of DNA is an important factor in causing cancer so that ethidium bromide is considered as a carcinogen or mutagen. Accordingly, the waste solution or pollutant containing ethidium bromide must be particularly treated in a way identical to the treatment of poisonous materials. At present, there are several methods for treating the waste solution or pollutant containing ethidium bromide, but these methods all have their inconveniences and defects. These treatment methods and their defects are described as below:
(1) The waste solution is diluted with water or alcohol and then is discarded into a sink—no any effect is achieved and the source of water and the environment may be polluted.
(2) The waste solution is exposed to the sun outdoors—said treatment needs much time to carry out and there must be a guard or a warning signal on the spot.
(3) The waste solution or pollutant is collected in the laboratory and then is transferred to relevant person in said institution for treating it—there must be a storage place, a person with expertise and a treatment place.
(4) The waste solution is treated with a strong acidic or a strong basic compound (Anal. Biochem. 1987, 162, 453)—such compounds include KMnO₄, HCl, NaOH, hypophosphorous acid, sodium nitrite and the like. Such a treatment method is too complicated and spends such a long time as 24 hours besides using strong acidic and strong basic compounds which are harmful to humans.
(5) The waste solution is treated with bleaching water—the waste solution containing ethidium bromide was treated with bleaching water (sodium hypochlorite solution) in the past, but it is reported that after treatment the fluorescent structure of ethidium bromide (carcinogen originally present in the solution) is destroyed, however the other carcinogens are produced in a minor amount so that the waste solution containing ethidium bromide after treatment can not be directly discarded into a sink (Anal. Biochem. 1987, 162, 453). Said document suggests that the waste solution containing ethidium bromide be not treated with bleaching water. After that time, many institutions and documents raised objection to, or inhibit the treatment of waste solution containing ethidium bromide with bleaching water.
(6) Commercially available products—there are two classes of commercially available products at present as follows:
   a. Powdery or granular activated carbon in a packet—since ethidium bromide is adsorbed by said activated carbon through contact principle, it takes much time (e.g. for 24 hours) to treat the solution with however a fear that the treatment is not complete, that is to say, the amount of ethidium bromide well treated is minor.
   b. A cation exchange resin—during the treatment ethidium bromide present in the waste solution is adsorbed on the ion exchange resin through core filtration. Treatment with said resin has a defect that the procedure is too complicated and the cost is rather expensive.

### THE CONTENT OF THE INVENTION

The prior methods for treating ethidium bromide is too complicated, expensive in cost, can not destroy the structure of carcinogenic ethidium bromide, or can not remove out of the waste solution the other carcinogens produced after treatment. After the inventor's researching, it is found that the agent of the invention have the following advantages: (1) treatment with the agent merely spends the time of from 5 minutes to 20 minutes, (2) the treated amount is lager and the cost of said treatment is lower as compared with ion exchanging resin, and (3) the structure of ethidium bromide is destroyed and the other carcinogenic compound produced after treatment is adsorbed, simultaneously. When used, the agent is merely thrown into the waste solution containing ethidium bromide in a collection barrel or beaker, and after 5-20 minutes, the agent is discarded by filtration and the waste solution after treatment is directly poured into a sink.

The present invention relates to an agent for destroying ethidium bromide comprising
(a) 67% to 99.9% (w/w) of an activated carbon material,
(b) 0.1% to 33% (w/w) of at least one of the compounds selected from hypochlorite, chlorite and chloro-containing compound.

The present invention further relates to an agent for destroying ethidium bromide comprising
(a) 44% to 55% (w/w) of an activated carbon material,
(b) 0.1% to 18% (w/w) of at least one of the compounds selected from hypochlorite, chlorite and chloro-containing compound, and
(c) 36% to 55% (w/w) of an inorganic mineral for increasing the specific weight of the mixture of the aforesaid (a) and (b),

The present invention further relates to an agent for destroying ethidium bromide comprising
(a) 44% to 55% (w/w) of an activated carbon material,
(b) 0.1% to 18% (w/w) of at least one of the compounds selected from hypochlorite, chlorite and chloro-containing compound,
(c) 36% to 55% (w/w) of an inorganic mineral for increasing the specific weight of the mixture of the aforesaid (a) and (b), and
(d) a packaging material pervious to gas and water.

The present invention also relates to a method for treating a carcinogenic waste solution containing ethidium bromide comprising contacting the agent of the present application with the carcinogenic waste solution containing ethidium bromide.

In the agent of the present invention, the activated carbon material has a porous structure and a high specific surface area and thus has high adsorptive capacity toward hydrocarbonous organic solvent, a carcinogen in the form of solid, liquid or gas, a poisonous ion (e.g. Cl) and the like. The uses of the activated carbon material generally include the followings:
a. the adsorption or recovery of an organic solvent—for instance, the adsorption and recovery of an organic solvent such as a corrosive chlorinated compound, a reactive solvent, a solvent having low melting point and the like.
b. the purification of air—the removal of a stench gas such as an amine, hydrogen sulfide, dimethyl sulfide and aromatic gas having carcinogenic property.
c. the treatment of sewage—the treatment of a phenol and an organic waste which is difficult to decompose by a microorganism.
d. the purification of water—for instance, the removal of residual chlorine in tap water.

The activated carbon material in the present invention is used to adsorb the chemical substances in the solution including chemical product after reaction, residual compounds such as hypochlorite, chlorite, ethidium bromide and the like into its pores by virtue of its high adsorptive capacity

The activated carbon materials contained in the agent of the present invention include, but is not limited to, preferably powdery activated carbon, granular activated carbon, activated carbon fiber blanket or activated carbon fiber cloth.

The amount of activated carbon materials contained in the agent of the present invention is 30% to 99.9% (w/w), preferably 40%-80% (w/w), more preferably 45%-60% (w/w).

Hypochlorites, chlorites or chloro-containing compounds contained in the agent of the present invention, such as calcium hypochlorite, potassium hypochlorite, sodium hypochlorite, ammonium hypochlorite, barium hypochlorite, magnesium hypochlorite, zinc hypochlorite, sodium chlorite, aluminum chlorite or sodium dichloroisocyanurate, can chemically react with ethidium bromide, and thereby can rapidly destroy the structure of ethidium bromide.

The amount of hypochlorites, chlorites or chloro-containing compounds contained in the agent of the present invention, is 0.1-25% (w/w), preferably 1-18%(w/w), more preferably 5-12% (w/w).

The inorganic mineral for increasing the specific weight of the mixture of the aforesaid two types of the materials contained in the agent of the present invention includes, but is not limited to, inorganic mineral which is capable of increasing the specific weight of the agent for treating ethidium bromide to make the agent after treatment sink to the bottom of the container, such as stone, clay, kaolin. The function of the inorganic mineral has two advantages as below:
a. ability in acting as a reference basis for determining whether the reaction is completed—since activated carbon material in the initiation of the reaction contain gases therein, the specific weight of the agent is relatively low (e.g. <1) so that the agent floats on the aqueous solution. When the reaction is nearly completed, the most of gases contained in the activated carbon materials are replaced with water molecules or chemical materials in the aqueous solution so that the specific weight (e.g. >1) of the agent becomes larger than that of the agent in the initiation of the reaction and this will enable the agent to sink to the bottom of the container at this time. So, whether the agent sinks or not can act as a reference basis for determining the state of the reaction.
b. ability in reducing the residual amount of ethidium bromide and the other chemical materials—the agent which sinks to the bottom of the container can continually reacts with ethidium bromide or the other chemical materials staying at the bottom of the container to reduce the final residual amount of ethidium bromide and the other chemical materials.

The amount of the inorganic mineral for increasing the specific weight of the mixture of the aforesaid two types of the materials contained in the agent of the present invention is 25-55% (w/w), preferably 36-50% (w/w), more preferably 44-48% (w/w).

The material for packaging the agent of the present invention includes, but is not limited to, non-woven cloth or activated carbon fiber in small bag form.

### EXAMPLES

### Example 1

### Determination on the Ability in Removing Ethidium Bromide (1) (by Ultraviolet-Fluorescence Test)

Onto the center of each of six sheets of filter papers having a diameter of 2.5 cm, 100 μl of 2.5 μg/ml ethidium bromide aqueous solution was allowed to drop with a micro-pipette. Then, 100 μl of each of five types of solvents and solutions as follows: (1) purified water, (2) 100% ethanol, (3) 0.5% (w/v) calcium hypochlorite aqueous solution, (4) 0.5% (w/v) sodium chlorite aqueous solution, (5) 0.5% (w/v) sodium dichloroisocyanurate aqueous solution, were respectively allowed to drop to the center of each of five of the six sheets of filter papers mentioned-above where ethidium bromide is located, while the remaining one filter paper was not treated as control experiment group (referred to as NC hereinafter). These six filter papers were allowed to stand at room temperature and were then inspected by ultraviolet light at time points of 0, 15, 30, 60 minutes. FIG. 1 showed that after standing for even 60 minutes no reaction could be found to have occurred in the experiment groups where water and 100% ethanol were respectively used when compared with control experiment group; in the experiment group where 0.5% (w/v) calcium hypochlorite aqueous solution was used the structure of ethidium bromide was destroyed into a non-fluorescent substance after standing for 15 minutes; in the experiment group where 0.5% (w/v) sodium chlorite aqueous solution was used the structure of ethidium bromide was destroyed into a non-fluorescent substance after standing for 30 minutes; and in the experiment group where 0.5% (w/v) sodium dichloroisocyanurate aqueous solution was used the structure of ethidium bromide was destroyed into a non-fluorescent substance after standing for 15 minutes.

### Example 2

### Determination on the Ability in Removing Ethidium Bromide (2) (by Ultraviolet-Fluorescence Test)

Into four of five beakers each containing 30 ml of 2.5 μg/ml ethidium bromide aqueous solution the following four agents were added respectively: (1) 0.5 g of granular activated carbon, (2) 0.5 g of granular activated carbon plus 50 mg of calcium hypochlorite in powder form, (3) 0.5 g of granular activated carbon plus 50 mg of sodium chlorite in sheet form, and (4) 0.5 g of granular activated carbon plus 50 mg of sodium dichloroisocyanurate in powder form. No treatment was made to the remaining beaker as control experiment group (referred to as NC hereinafter). These beakers were shaken for several minutes and then were allowed to stand at room temperature. At time points of 0, 15, 30, 60 minutes, 100 μl of each of the five types of the solutions in the beakers were respectively sucked by a micro-pipette and then was respectively allowed to drop on filter papers having a diameter of 2.5 cm. Subsequently, these filter papers were inspected with an ultraviolet light. FIG. 2 showed that the amount of ethidium bromide merely mixed with the granular activated carbon was decreased with the increase in the reaction time, however ethidium bromide was still present after 60 minutes; in the other three experiments (activated carbon plus sodium chlorite, activated carbon plus calcium hypochlorite, and activated carbon plus sodium dichloroisocyanurate) ethidium bromide was converted into a non-fluorescent substance after reaction for 15 minutes.

### Example 3

### Determination on the Ability in Removing Ethidium Bromide (3) (by Ultraviolet-Fluorescence Test)

Into six 500-ml beakers each containing 300 ml of 1 μg/ml ethidium bromide aqueous solution there were respectively placed the following six types of the agents for treating ethidium bromide prepared as follows: (1) 2.5 g of granular activated carbon, 25 mg of calcium hypochlorite in powder form and 2.0 g of stone were placed into a small bag of a non-woven fibric in the dimension of 6.5 cm in length and 3.5 cm in width and then was sealed by a sealing machine, (2) 2.5 g of granular activated carbon, 1 g of calcium hypochlorite in powder form and 2.0 g of stone were placed into a small bag of a non-woven fabric in the dimension of 6.5 cm in length and 3.5 cm in width and was then sealed by a sealing machine, (3) 2 g of granular activated carbon, 25 mg of sodium chlorite in sheet form and 2.5 g of stone were placed into a small bag of a non-woven fabric in the dimension of 6.5 cm in length and 3.5 cm in width and then was sealed by a sealing machine, (4) 2 g of granular activated carbon, 1 g of sodium chlorite in sheet form and 2.5 g of stone were placed into a small bag of a non-woven fabric in the dimension of 6.5 cm in length and 3.5 cm in width and was then sealed by a sealing machine, (5) 2 g of granular activated carbon, 25 mg of sodium dichloroisocyanurate in powder form and 2.5 g of stone were placed into a small bag of a non-woven fabric in the dimension of 6.5 cm in length and 3.5 cm in width and was then sealed by a sealing machine, and (6) 2 g of granular activated carbon, 1 g of sodium dichloroisocyanurate in powder form and 2.5 g of stone were placed into a small bag of a non-woven fabric in the dimension of 6.5 cm in length and 3.5 cm in width and was then sealed by a sealing machine. Then, these six beakers were allowed to stand at room temperature. At time points of 0, 5 and 10 minutes, 100 μl of each of these six thus treated solutions were sucked with a micro-pipette and was respectively allowed to drop on a filter paper having the diameter of 2.5 cm and was then inspected by an ultraviolet light. FIG. 3 showed that (1) ethidium bromide present in the first and the third treated solutions was mostly converted to a non-fluorescent substance after reaction for 5 minutes, and these two solutions had no fluorescent substance after reaction for 10 minutes, (2) ethidium bromide present in the second, fourth, fifth and sixth treated solutions are converted to a non-fluorescent substance after reaction for 5 minutes.

### Example 4

### Determination on the Ability in Removing Ethidium Bromide (4) (by Ultraviolet-Fluorescence Test)

Into 500 ml of 1 μg/ml ethidium bromide aqueous solution there was placed an agent for treating ethidium bromide prepared as follows: 4 g of activated carbon fiber cloth and 0.008 of sodium dichloroisocyanurate in powder form were placed into a small bag of a non-woven fabric in the dimension of 7.0 cm in length and 7.0 cm in width and was then sealed by a sealing machine. Then, the solution thus treated is allowed to stand at room temperature. At time points of 0, 15 and 30 minutes, 100 μl of each of the treated solutions and non-treated solution was respectively sucked with a micro-pipette and was respectively allowed to drop on filter papers having the diameter of 2.5 cm and was inspected with an ultraviolet light. FIG. 4 showed that ethidium bromide present in the solution was converted to a non-fluorescent substance after reaction for 15 minutes.

The results of Example 1 demonstrated that purified water and ethanol exerted no effect on ethidium bromide, whereas calcium hypochlorite, sodium chlorite or sodium dichloroisocyanurate aqueous solution alone were capable of destroying the structure of ethidium bromide. However, the prior art reference (Anal. Biochem. 1987, 162, 453) indicated that ethidium bromide having been treated with a certain compound still may be transformed into other carcinogens in a trace amount, therefore ethidium bromide even having been treated could not be directly discarded or poured into a sink. For solving this problem, in Example 2, the experiment agent included activated carbon materials having activity in adsorbing carcinogenic materials, besides a compound which could react with ethidium bromide. The results of Example 2 also demonstrated that the combination of these two types of materials. could rapidly destroy ethidium bromide with simultaneously adsorbing residual carcinogenic materials. In Example 3 there was shown a process in practically treating an aqueous solution of ethidium bromide with an agent in product form as experiment material. The results also showed that these agents and the process were effective, safe, rapid, simple in operation and were able to completely remove the carcinogenicity of ethidium bromide. Example 4 further illustrated the range of the amount of activated carbon materials and the chloro-containing compounds.

### BRIEF DESCRIPTION OF DRAWINGS

FIG. 1: Results showing the ability of the agents in removing ethidium bromide determined by ultraviolet-fluorescence test.

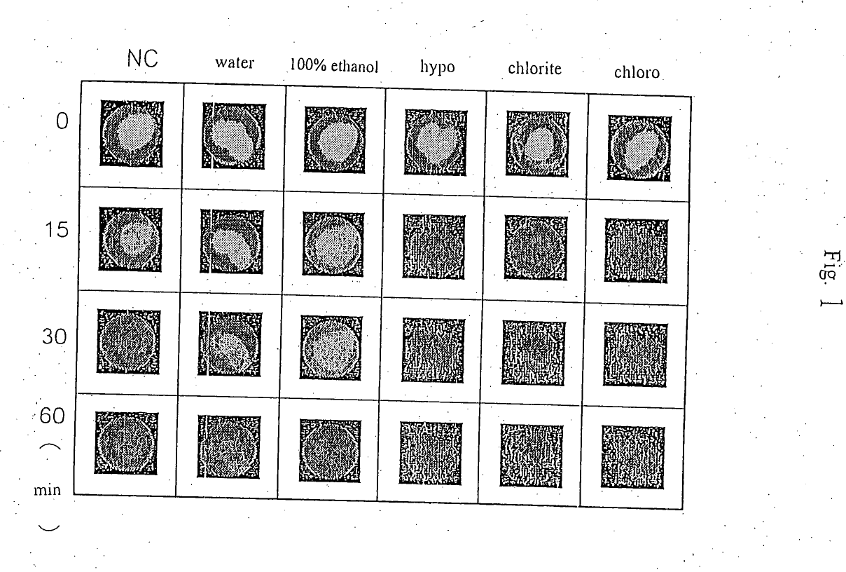

On the longitudinal axis there are listed the reaction times and on the latitudinal axis there are listed the agents where NC: control experiment, water: purified water allowed to drop on a filter paper, 100% ethanol: 100% ethanol allowed to drop on a filter paper, hypo: 0.5% (w/v) calcium hypochlorite aqueous solution allowed to drop on a filter paper, chlorite: 0.5% (w/v) sodium chlorite aqueous solution allowed to drop on a filer paper, chloro: 0.5% (w/v) sodium dichloroisocyanurate aqueous solution allowed to drop on a filter paper.

FIG. 2: Results showing the ability of the agents in removing ethidium bromide determined by ultraviolet-fluorescence test.

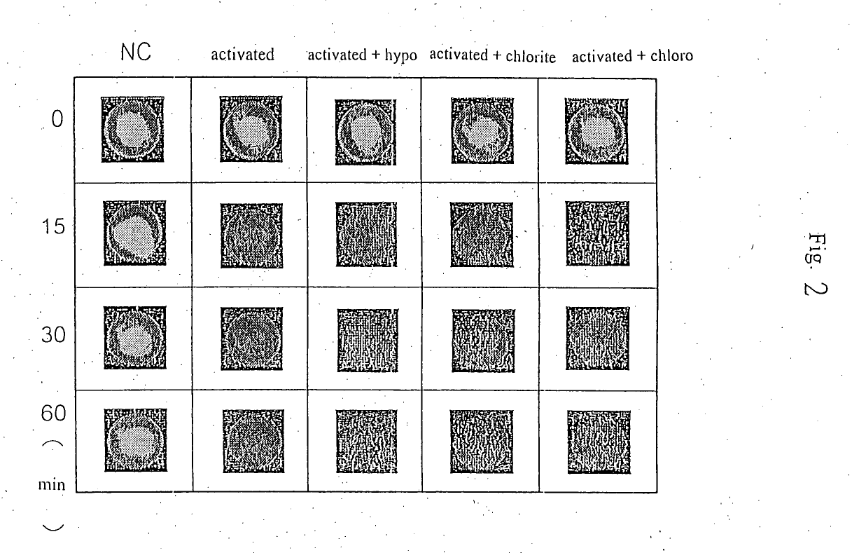

On the longitudinal axis there are listed the reaction times and on the latitudinal axis there are listed the agents used where NC: control experiment, activated: activated carbon materials, activated+hypo: activated carbon+calcium hypochlorite, activated+chlorite: activated carbon+sodium chlorite, activated+chloro: activated carbon+sodium dichloroisocyanurate.

FIG. 3: Results showing the ability of the agents in removing ethidium bromide determined by ultraviolet-fluorescence test.

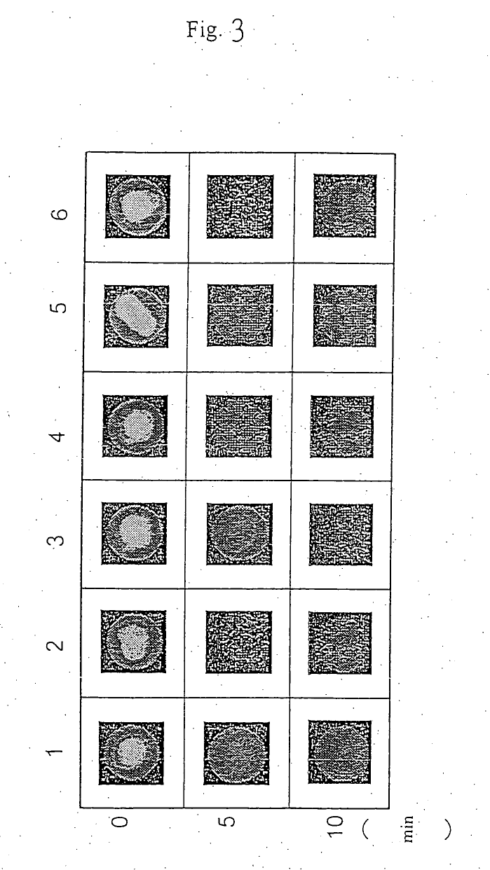

On the longitudinal axis there are listed the reaction times and on the latitudinal axis there are listed six different agents used 1: the first agent, 2: the second agent, 3: the third agent, 4: the fourth agent, 5: the fifth agent, 6: the sixth agent as defined in Example 3.

FIG. 4: Results showing the ability of the agents in removing ethidium bromide determined by ultraviolet-fluorescence test.

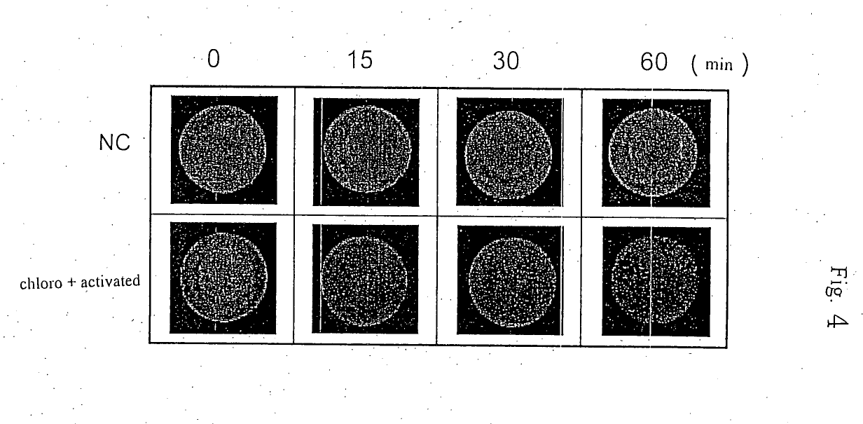

On the longitudinal axis there are listed reaction times and on the latitudinal axis there are listed the agents used where NC: control experiment, chloro+activated: sodium dichloroisocyanurate+activated carbon.

The present invention has been described in terms of specific embodiments incorporating details to facilitate the understanding of construction and operation of the invention. It will be apparent to those skilled people in the art that modification may be made in the embodiment chosen for illustration without departing from the spirit and scope of the invention.

1. An agent for destroying ethidium bromide, which comprises:
(a) 67% to 99.9% (w/w) of an activated carbon material,
(b) 0.1% to 33% (w/w) of at least one of the compounds selected from hypochlorite, chlorite and chloro-containing compound.

2. An agent for destroying ethidium bromide, which comprises:
(a) 44% to 55% (w/w) of an activated carbon material,
(b) b 0.1% to 18% (w/w) of at least one of the compounds selected from hypochlorite, chlorite and chloro-containing compound, and
(c) 36% to 55% (w/w) of an inorganic mineral for increasing the specific weight of the mixture of the aforesaid (a) and (b).

3. The agent according to claim 1 or 2, wherein said activated carbon material may be powdery activated carbon, granular activated carbon, activated carbon fiber blanket or activated carbon fiber cloth.

4. The agent according to claim 1 or 2, wherein said component (b) may be in a solid or liquid form.

5. The agent according to claim 1 or 2, wherein said component (b) is calcium hypochlorite, sodium chlorite and sodium dichloroisocyanurate.

6. The agent according to claim 1 or 2, which is packaged in a packaging material.

7. A method for treating a carcinogenic waste solution containing ethidium bromide, which comprises contacting the agent according to claim 1 or 2 with the carcinogenic waste solution containing ethidium bromide.
